(19) United States
(12) Patent Application Publication
(10) Pub. No.: US 2007/0258746 A1
(43) Pub. Date: Nov. 8, 2007

(54) Key configuration for accelerated backspace operation

(75) Inventors: Gary I. Dickenson, Tucson, AZ (US); Andrew E. Seidel, Tucson, AZ (US)

Correspondence Address: QUARLES & BRADY LLP, 1 SOUTH CHURCH AVENUE, SUITE 1700, TUCSON, AZ, 85701, US

(73) Assignee: International Business Machines Corporation, Armonk, NY (US)

(21) Appl. No.: 11/416,372

(22) Filed: May 2, 2006

(51) Int. Cl. B41J 5/00

(52) U.S. Cl. 400/472

(57) ABSTRACT

A computer keyboard includes a first key having a first function positioned adjacent to a second key having the first function, both keys integrated into the computer keyboard. Each of the keys is independently operable to perform a rapid operation of the first function. The keys are operable to be depressed in an alternating manner to perform the first function, such as an accelerated backspace function. A keyboard includes first and second backspace keys separated by a zigzagged boundary, again integrated into the keyboard. A method of manufacturing a keyboard includes providing a first key having a first function positioned adjacent to a second key having the first function, again integrated into the keyboard.

### BACKGROUND OF THE INVENTION

1. Field of the Invention

The present invention relates in general to computers, and more particularly, to a keyboard and key configuration for an accelerated backspace operation.

2. Description of the Prior Art

Computer keyboards have become commonplace in everyday society. The devices are utilized to enter text and perform basic input and output commands, among a host of other functions. The so-called PC/XT, 83-key keyboard was produced by IBM Corporation for the first generation of personal computers. The next generation PC/AT, 84-key keyboard improved upon the basic PC/XT design. Over the years, several improvements in keyboard configuration and layout were implemented, including the addition of additional keys to perform specialized computing functions. Computer keyboards have continued to evolve to become more ergonomic and functional. More recently, computer keyboards have incorporated wireless protocols such as so-called “Bluetooth” to communicate wirelessly with a host computer.

Even in light of the many innovations that have graced the standard computer keyboard, typists continue to encounter difficulties. Frequently, when editing text documents, there is a need to delete a series of characters by backspacing over them. The design of standard computer keyboards provides a single “backspace” key. FIG. 1 shows a prior art example of a computer keyboard 10. Keyboard 10 includes such familiar keys as a spacebar 12, letter “T” key 14, enter key 16, and backspace key 18.

Because standard keyboard configurations such as that depicted in FIG. 1 include a single backspace key, a user can delete characters only as fast as the single key can be repeatedly pressed. This is not only slow, but also contributes to injuries from repetitive motion. As a result, a need exists for a configuration and method of implementation for an accelerated backspace operation when using a computer keyboard.

### SUMMARY OF THE INVENTION

In one embodiment, the present invention is a keyboard comprising a first key having a first function positioned adjacent to a second key having the first function, the first and second keys integrated into the keyboard.

In another embodiment, the present invention is a keyboard comprising first and second backspace keys separated by a zigzagged boundary, the first and second backspace keys integrated into the keyboard.

In still another embodiment, the present invention is a method of manufacturing a keyboard, comprising providing a first key having a first function positioned adjacent to a second key having the first function, the first and second backspace keys integrated into the keyboard.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a prior art example of a standard computer keyboard; and

FIG. 2 illustrates a key configuration for an accelerated backspace operation.

### DETAILED DESCRIPTION OF THE DRAWINGS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

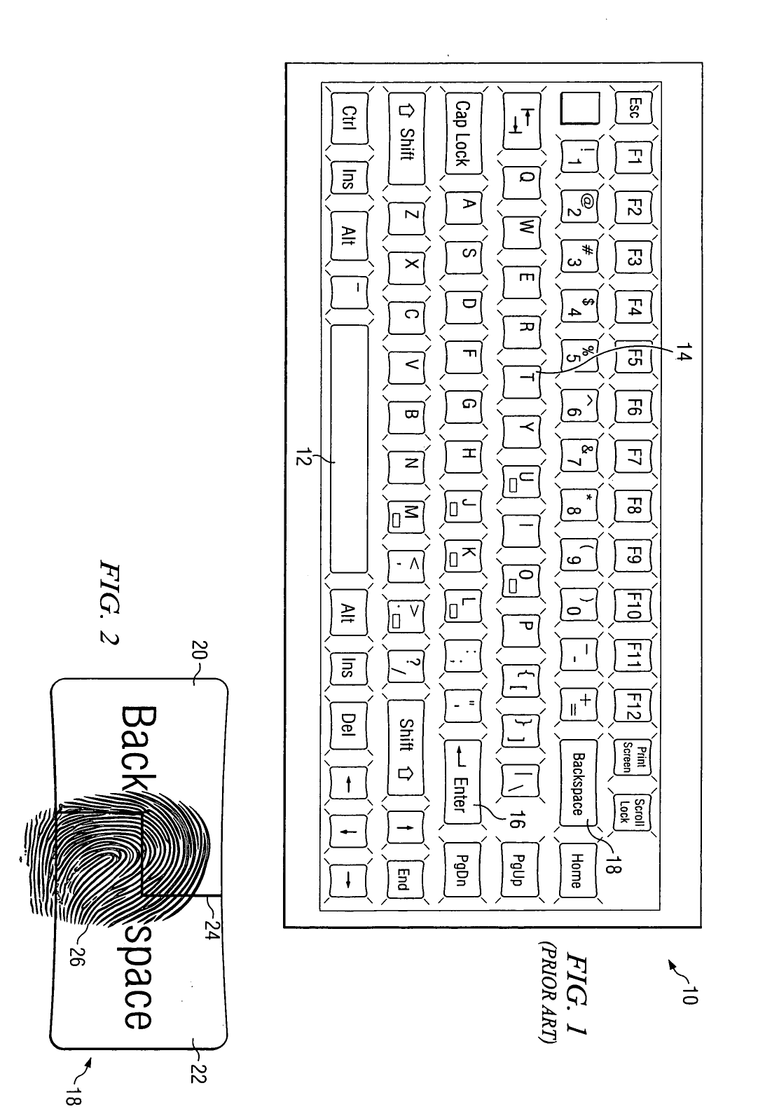

Turning to FIG. 1, an embodiment of a key configuration for an accelerated backspace operation is shown. What would normally occupy the location of a single backspace key 18 in keyboard 10 instead includes two backspace keys 20, 22. Backspace keys 20, 22 are intended to have an identical function. Keys 20, 22 are configured such that the keys 20, 22 can be operated as either a single key 18 if the user wants to delete text as is done with a standard keyboard 10. Alternatively, keys 20, 22 can be operated independently, in an alternating manner so the speed of text backspacing can be increased. By allowing a dual mode of operation of keys 20, 22, repetitive motion injuries are lessened by decreasing the number of identical motions and by interrupting one motion with a second, different motion.

Keys 20, 22 are located side-by-side in the location of a traditional large backspace key 18. Key 20 is positioned adjacent to key 22. Keys 20, 22 are separated by a zigzagged boundary 24. Boundary 24 allows keys 20, 22 to be operable such that a user can press both keys 20, 22 simultaneously with the depression of a single finger 26. Keys 20, 22 can be independently depressed, resulting in a backspace operation that is normally seen in a traditional keyboard when an individual backspace key 20 or key 22 is depressed.

Again, to delete a single character, a user depresses either key 20 or key 22 a single time to perform the traditional backspace operation. To perform an accelerated backspace operation (rapidly backspace), the user depresses key 20 with her index finger, releases key 20 and presses key 22 with her third finger, and releases key 22, repeating the motion to trigger a rapid or accelerated backspace operation.

Again, keys 20, 22 can be depressed simultaneously with a single finger to perform a specialized backspace operation. For example, a simultaneous depression of keys 20, 22 can result in the same accelerated backspace operation as previously described by alternately depressing keys 20, 22. In a separate embodiment, keys 20, 22 can be depressed simultaneously to perform an additional backspace-related operation, such as deleting an entire word or a similar operation.

Keys 20, 22 can be designed to perform additional functions other than an accelerated backspace operation. For example, keys 20, 22 can be positioned where a traditional enter key 16 is located on a traditional keyboard 10 to perform an accelerated enter function. In this embodiment, as with other embodiments of the present invention, keys 20, 22 perform the same function when independently depressed. Key 20 performs a specific function, such as the enter function. Key 22, positioned adjacent to key 20, also performs the enter function. Keys 20, 22 can be operable to perform an accelerated enter function when alternately depressed in the same manner as previously described. Additionally, keys 20, 22 can be depressed simultaneously to perform a specialized function such as beginning a new paragraph or new page, or inserting a page break.

Keys 20, 22 can be programmed to perform a specialized function, which can be user defined. For example, a user can designate a simultaneous depression of keys 20, 22 to insert a special character such as a section symbol (§). Properties such as the rate of acceleration associated with an accelerated backspace operation can also be user-adjustable.

A computer keyboard incorporating keys 20, 22 can be manufactured using traditional techniques known in the art such as injection molding or similar thermoformed methods. The keyboard can include a microprocessor and control circuitry, again not unlike those known in the art. The keyboard can incorporate various switching methods, such as capacitive or mechanical switching. The keyboard can include rubber dome switches. Finally, the keyboard can incorporate a continuous membrane, metal contact switches, or foam elements.

While one or more embodiments of the present invention have been illustrated in detail, the skilled artisan will appreciate that modifications and adaptations to those embodiments may be made without departing from the scope of the present invention as set forth in the following claims.

What is claimed is:

1. A keyboard, comprising:
a first key having a first function positioned adjacent to a second key having the first function, the first and second keys being integrated into the keyboard.

2. The keyboard of claim 1, wherein the first and second keys are operable to perform an accelerated operation of the first function when depressed in an alternating manner.

3. The keyboard of claim 1, wherein a boundary separating the first and second keys is zigzagged to allow a user to depress the first and second keys simultaneously.

4. The keyboard of claim 1, wherein the first and second keys perform a backspace, enter, tab, space, or shift function.

5. A keyboard, comprising:
first and second backspace keys separated by a zigzagged boundary, the first and second backspace keys being integrated into the keyboard

6. The keyboard of claim 5, wherein the first and second backspace keys are operable to perform an accelerated backspace operation when depressed in an alternating manner.

7. The keyboard of claim 5, wherein the zigzagged boundary allows for the first and second backspace keys to be depressed simultaneously by a single finger.

8. A method of manufacturing a keyboard, comprising:
providing a first key having a first function positioned adjacent to a second key having the first function, the first and second keys being integrated into the keyboard.

9. The method of manufacturing of claim 8, wherein the first and second keys are operable to be depressed in an alternating manner to perform an accelerated operation of the first function.

10. The method of manufacturing of claim 8, wherein a boundary separating the first and second keys is zigzagged to allow a user to depress the first and second keys simultaneously.

11. The method of manufacturing of claim 8, wherein the first and second keys perform a backspace, enter, tab, space, or shift function.
